(19) United States
(12) Patent Application Publication
(10) Pub. No.: US 2008/0026209 A1
(43) Pub. Date: Jan. 31, 2008

(54) AUTOMOTIVE PANEL HAVING POLYURETHANE PRIMER

(76) Inventor: Sunitha Grandhee, Novi, MI (US)

Correspondence Address: EXATEC;C/O BRINKS HOFER GILSON & LIONE, P. O. BOX 10395, CHICAGO, IL, 60610, US

(21) Appl. No.: 11/829,671

(22) Filed: Jul. 27, 2007

Related U.S. Application Data
(60) Provisional application No. 60/834,353, filed on Jul. 28, 2006.

(51) Int. Cl. B32B 25/08

(52) U.S. Cl. 428/336; 428/334; 428/335; 428/339; 428/412; 428/480; 428/500

(57) ABSTRACT

An automotive panel is disclosed. The automotive panel comprises a polycarbonate base layer, an aqueous polyurethane primer coated on the polycarbonate base layer, and a weatherable coating applied on the aqueous polyurethane primer. The aqueous polyurethane primer comprises less than about 10 weight percent of polyurethane and less than about 30 weight percent 2-butoxyethhanol with the remainder being deionized water. The primer may contain additives like ultraviolet absorbers, flow additives, antioxidants.

### CROSS-REFERENCE TO RELATED APPLICATIONS

This application claims the benefit of U.S. Provisional Application Ser. No. 60/834,353, filed on Jul. 28, 2006, entitled “Moisture Insensitive Plastic Glazing,” the entire contents of which are incorporated herein by reference.

### FIELD OF THE INVENTION

The present invention relates to plastic automotive panels or glazings having polyurethane primers.

### BACKGROUND OF THE INVENTION

For many years, glass has been a component used for windows in the automotive industry. As known, glass provides a level of abrasion resistance and ultraviolet radiation (UV) resistance acceptable to consumers for use as a window in vehicles. Although adequate in that respect, glass substrates are characteristically relatively heavy which translates to high costs in delivery and installment. Moreover, the weight of glass ultimately affects the total weight of the vehicle. Plastic materials have been used in a number of automotive engineering applications to substitute glass, enhance vehicle styling, and lower total vehicle weight and cost. An emerging application for transparent plastic materials is automotive window systems.

The use of aqueous coatings has advantage of being able to coat directly onto highly stressed polycarbonate parts without causing crazing and defects typically of conventional solvent based systems. In addition, the use of primarily aqueous compositions reduces solvent emission during manufacturing resulting in a more environmentally friendly process with all the corresponding economic advantages.

Unfortunately, unlike solvent based organic coating, aqueous based polymer coatings suffer from moisture uptake during accelerated and real world testing. This is seen in water soak tests, humidity exposure and weathering tests both accelerated and real world (fleet testing). The moisture uptake manifests itself in a generalized blushing or haziness of the part and can be uniform or patterned depending on the uniformity of the coating.

Current primer systems form both uniform and patterned haze greater than about 1 percent when exposed to water greater than 40 degrees Celsius. In this formulation, the moisture uptake of the primer, being about 10 percent by volume, is attributed to the acrylic emulsion polymers.

There is a need in the industry to improve glass substitute window systems for improved functionality, such as weatherability, adhesion, abrasion resistance, and UV resistance.

### BRIEF SUMMARY OF THE INVENTION

The present invention generally provides an improved glass substitute window system having improved functionalities such as weatherability, adhesion, abrasion resistance, and UV resistance.

Embodiments of the present invention provide an aqueous based coating system. The aqueous based coating system is water insensitive and has advantages for polycarbonate (PC) glazing, allowing drivers and passengers to see through with no defects and low overall haze of less than about 1 percent.

One embodiment of the present invention provides an automotive panel or glazing. The panel comprises a polycarbonate base layer, an aqueous polyurethane primer coated on the polycarbonate base layer, and a weatherable coating applied on the aqueous polyurethane primer. The aqueous polyurethane primer comprises less than about 10 weight percent of polyurethane and less than about 30 weight percent of 2-butoxyethanol with the remainder being deionized water.

In another embodiment, the present invention provides the automotive panel comprising the aqueous polyurethane primer having an acid number of about 20 mg KOH/gm dry resin while comprising less than about 10 weight percent of polyurethane and less than about 25 weight percent 2-butoxyethanol with the remainder being de-ionized water. The panel further comprises an abrasion resistant layer adhered to the weatherable coating for protecting the panel from damage caused by abrasion.

Surprisingly, aqueous based formulations of organic polymer dispersions with acid numbers below 40 and water swell ratio of less than 5% results in a substantially water insensitive hydrophobic coating for PC glazing systems. These are particularly useful to act as an adhesion promoter to tie silicon hard coatings to polycarbonate. In addition, these systems may be coated in what is called a wet-on-wet system rather than a bake-on-bake system. This will result in reduced capital cost in manufacturing line design.

Such coatings can also have functional additives added to them. An example of such an additive can be ultraviolet (UV) adsorbing species to protect the polycarbonate from harmful UV light. With the UV adsorbing species present, thickness of the films can be increased substantially enough to replace a portion or all of the traditional silicon hard coat UV blocking layer. The organic coating may be substantially lower in cost per gallon than a silicon hard coat system.

These coatings can be applied by spray coating, flow, dip, rtain coating systems. These types of coatings have an added advantage that they may be cured at room temperature, and/or at shorter times, thereby reducing the cure time in manufacturing. As a result, this reduces expenses and increases yields.

Further objects, features, and advantages of the present invention will become apparent from consideration of the following description and the appended claims when taken in connection with the accompanying drawings.

### DETAILED DESCRIPTION OF THE INVENTION

Embodiments of the present invention provide an automotive panel or glazing generally comprising a base layer, an aqueous polyurethane primer applied on the base layer, and a weatherable coating coated on the primer. In one embodiment, the base layer may be comprised of but is not limited to polycarbonate, polymethylmethacrylate, polyester, a polycarbonate/acrylonitrile butadiene styrene blend, a polycarbonate/polyester blend, polyacrylate, and polysulfone, as well as copolymers and mixtures thereof. Preferably, the base layer comprises bisphenol-A polycarbonate and all other resin grades (such as branched or substituted) as well as being copolymerized or blended with other polymers such as PBT, ABS or polyethylene. The base layer may further be comprised of various additives, such as colorants, mold release agents, antioxidants, and ultraviolet absorbers (UVA), among others.

As mentioned above, an aqueous polyurethane primer is applied on the base layer. The aqueous polyurethane primer may comprise less than about 10 weight percent of polyurethane and less than about 30 weight percent of 2-butoxyethanol with the remainder being deionized water. In one example, the aqueous polyurethane primer has an acid number about 20 mg KOH/gm dry resin and has a thickness of less than about 1 micrometers. Preferably, the aqueous polyurethane primer comprises ultraviolet absorbing (UVA) molecules for ultraviolet light absorption. In this example, the UVA molecules are comprised of one of the following components: inorganic oxides, benzophenones, benzoylresorcinols, cyanoacrylates, triazines, oxanilides, and benzotriazoles. Preferably, the ultraviolet absorbing molecules exhibit greater than about 1 absorption unit of UV light absorption between the wavelengths of about 295 to about 345 nanometers.

In another example, the aqueous polyurethane primer comprises less than about 7 weight percent of polyurethane and less than about 25 weight percent of 2-butoxyethhanol with the remainder being deionized water. In this example, the aqueous polyurethane primer may also comprise triethylamine.

The aqueous polyurethane primer is coated on the base layer, and cured by air drying for 20-45 minutes or thermally cured between about 50° C. and 100° C. for between about 20 to 80 minutes.

In one example, the polyurethane aqueous primer comprises water as a first solvent and an organic liquid as a second co-solvent. The first solvent, water, preferably comprises greater than 10 wt. % of the polyurethane aqueous primer, more preferably greater than about 50 wt % of the primer, and most preferably greater than at least 60 wt. % of the primer. The general chemical classes associated with the second co-solvent present in the primer includes glycol ethers, ketones, alcohols and acetates with the co-solvent being present in less 90 wt % of the primer, more preferably less than about 50 wt % of the primer, and most preferably less than about 30 wt % of the primer.

For example, the second co-solvent present in the aqueous polyurethane primer is 2-butoxyethanol (also called ethylene glycol monobutyl ether). Resin content in this primer may be about 2-7 wt % of the primer with the remainder of the primer being made up of the first solvent and second co-solvent. Preferably, the amine in these primers is triethylamine. The resin may be present as a water soluble, dispersible, or reducible resin. Other resins may be utilized in the primer provided that the solvent system for this primer is similar to that described above. The primer may contain other additives, such as but not limited to surfactants, antioxidants, biocides, and drying agents, among others.

A weatherable coating or hard-coat is then applied on the primer and is air dried before curing at preferably between about 80° C. and 130° C. for between about 20 to 80 minutes and more preferably at about 100° C. for about 30 minutes. The weatherable coating may comprise at least one of the following components: acrylic, polyurethane, polyurethane-acrylate copolymer, siloxane, silicone hard-coat, ionomer, flouropolymer, and mixtures thereof. Preferably, a silicone hard-coat is used for the weatherable coating and is available from Exatec LLC and distributed by Momentive Performance Materials as Exatec® SHX.

In an alternative, the weatherable coating is one of a polyurethane and a polyurethane-acrylate. In this embodiment, the system having the coating printed and cured on the plastic substrate may have a thickness of preferably between about 10 and 65 microns, and may have Taber (delta percent haze) of between about 1% and 5% delta haze and preferably about 2% delta haze.

Polyurethane coatings are considerably less expensive than silicone hardcoats, and they can be applied at relatively high film thicknesses thus providing improved UV-protection for the underlying polycarbonate. Polyurethane coatings were originally defined as products made from polyisocyanates and polyols, but today one defines it more broadly and includes all systems based on a polyisocyanate whether the reaction is with a polyol, a polyamine or with water. This means that a polyurethane (PU) coating may contain urethane, urea, allophanate and biuret linkages. Polyurethane coatings have grown rapidly since they were first introduced decades ago for their highly versatile chemistry and superior properties particularly as to toughness, resistance to abrasion and chemicals while also being flexible and adhering well to all sorts of substrates.

An abrasion layer or topcoat is preferably applied on the weatherable coating that adds additional or enhanced functionality to the automotive panel, such as improved abrasion resistance. Although preferred, it is understood that the abrasion layer may be optionally applied on the weatherable coating. An example of such a coating is the abrasion resistant topcoat used in the Exatec® 900 glazing system. Preferably, the abrasion layer comprises at least one of the following components: aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, and mixtures thereof.

The abrasion layer may be applied by any technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include but are not limited to plasma enhanced chemical vapor deposition, ion assisted plasma deposition, magnetron sputtering, electron beam evaporation, and ion beam sputtering. Examples of atmospheric coating processes include but are not limited to curtain coating, spray coating, spin coating, dip coating, and flow coating.

The automotive panel of the present invention may be formed into a window through the use of any known technique to those skilled in the art, such as extrusion, molding, which includes injection molding, blow molding, and compression molding, or thermoforming, which includes thermal forming, vacuum forming, and cold forming. The forming of a window using the transparent plastic substrate may occur prior to printing, after printing, or after application of the primer/hard-coat system.

### EXAMPLES

Many aqueous polymers were evaluated as potential polymer systems for the primer layer. The objective was to look into a variety of aqueous based polymers such as high molecular weight latex polymers as well as relatively lower molecular weight polyurethanes. Table 1 below lists the various polymers that were either considered or evaluated.

TABLE 1

| | solids | pH |
|---|---|---|
| Water dispersible acrylics | | |
| Neocyl BT-520 | 38.3 | 7 |
| Neocyl XK-90 | 43.2 | 8.7 |
| Neocyl A-622 | 32 | 8.2 |
| Arolon ® 860-W-45 | 45 | 7.9 |
| Arolon 559-G4-70 | 70 | |
| Carboset 511 | 29 | 6.8 |
| Carboset 560 | 27 | 7.6 |
| Carboset 514H | 40 | 7 |
| Latex Emulsion Acrylics | | |
| Carboset 2813 | 42 | 8.3 |
| Carboset 2888 | 42 | 8 |
| Water dispersible Polyurethanes | | |
| L-2672 | 35 | 8 |
| HD-2501 | 40 | 8.5 |
| HD-2503 | 35 | 8 |
| HD-2504 | 35 | 8.5 |

Among the polymers that were evaluated, an aqueous polyurethane HD-2503™ and its equivalent L-2896™ (each from C. L. Hauthaway & Sons Corp.) in DMM (dipropylene glycol dimethyl ether) solvent performed relatively most favorably for low haze, good adhesion and satisfying other mechanical properties. Due to their environmental advantages, there is an incentive to use aqueous polyurethanes. Polyurethanes such as Hauthane polyurethanes are hydrophobic in nature. A Hauthane polyurethane, e.g., HD-2503™ or L-2896™, is a polycarbonate based, aliphatic water based dispersion that was developed for wood, plastic and metal and having thermal mechanical robustness. It has an acid number of about 20 mg KOH/gm dry resin and has a Tg at about 10 degrees Celsius. A Hauthane polyurethane comprises a neutralizing amine, e.g., triethyl amine.

In one example, HD-2503 and its equivalent L-2896 (in DMM solvent) were made as 2.4 weight % solutions and tested as provided in Table 2 below.

TABLE 2

| | Work Instruction & | |
|---|---|---|
| Test Tile | Standard Reference | Requirement |
| % Haze | ASTM D 1003 | Targeting <1% |
| % Light transmission | ASTM D 1003 | >70% for clear and solar |
| | | tints. (No spec for privacy |
| | | tints |
| | | >70% light transmission, |
| | | unless agreed upon with |
| | | customer.) |
| Cataplasma testing | Dow Automotive AG - | >80% cohesive failure of the |
| (bonding system) | Test method No 039E | PU bonding systems on |
| | Cataplasma Treatment | black out area |
| Chemical resistance | ANSI Z26.1-1996 | No appearance flaws, |
| | | tackiness or adhesion loss |
| Color (YI, L, a, b) - substrate | ASTM D 1925, E 313 | |
| Cross-hatch tape adhesion | ASTM D 3359 | ≧99% initial adhesion |
| | | retention on all relevant |
| | | areas |
| 1 day 50 C. water soak | | <1% delta haze |
| 30 day 50 C. water soak | | <5% delta haze |
| Coating thickness | | [0.2-0.8 um], |
| Weathering | ASTM G154 Cycle 4 | |
| Optical distortion | Exatec Protocol/Dioptimetry | Pass |
| Defroster test (Performance | SAE J953 | No failure after 2 hrs 15 V. |
| & durability) | | |
| Elongation stress cracking | | Stress crack formation @ >1.1% |
| | | elongation |
| Falling dart impact | ASTM D 3763 | >90% ductile failures at −30° C. |
| GMOD CIRA/Soda lime | | >0.2 MJ/m2 |
| Heat aging | 8 weeks @ 90° C. | Adhesion retention >96%, no |
| | | visual defects, DYI similar |
| | | to existing product |
| Lap shear (bonding system) | ASTM D 3163 | Average bond strength >500 psi |
| Solar properties | ISO 9050, SAE J1769. | |
| Solvent Stress Test | | No cracks in ink/coating after |
| | | curing of 3000 psi surface |
| | | stress part. |
| Taber abrasion | ASTM D 1044 | e side <2.0% haze/i side |
| | | <10% haze |
| Thermal cycling | | Adhesion retention ≧96%, no |
| | | visual defects. |
| Visual inspection | | Pass in all relevant areas |

An aqueous formulation of the polyurethane was made using the procedure discussed herein. About 67 weight percent of deionized water was weighed and about 7 weight percent of an aqueous polyurethane resin, PUR HD-2896 (discussed above), was weighed and mixed with the deionized water to define a PUR-water mixture. About 25 weight percent of 2-butoxyethanol was weighed and added to the mixture, defining a polyurethane solution. The solution was mixed under low speed for about 15 minutes. Table 3 below summarizes the procedure.

TABLE 3

| Ingredient | Amount | Procedure |
|---|---|---|
| D.I.Water | 67.26 | Weigh DI water Weigh PUR into the |
| | | mixture. |
| PUR HD-2896 | 6.82 | Mix under low speed for 15 minutes |
| 2-butoxyethanol | 25.92 | Weigh EB and add to the mixture above |
| Total | 100.00 | Mix under low speed for 15 minutes |

Five gallons of the aqueous polyurethane primer were made and coated on polycarbonate base layers that were then subjected to the tests listed above. The shelf stability of the liquid primer was monitored and showed no signs of settling after three months. The aqueous polyurethane primer showed significantly less haze after water immersion testing than an aqueous acrylic primer.

The water immersion test includes an initial cross-hatch adhesion test (tape pull) according to ASTM D3359-95 and is followed by submerging the printed polycarbonates in distilled water at elevated temperatures of about 65 degrees Celsius for approximately 10 days. The adhesion of the ink and coating is tested about every other day up to a maximum of 10 days. An ink passes the test only if greater than 95% retention of ink. Testing of any optional coating may be conducted on the 10^{th} day. This is checked using the cross hatch tape test according to ASTM D-3359.

Ten 730 plaques (730 mm×730 mm) were coated with the aqueous polyurethane formulation. Five plaques were flashed for about 40 minutes at room temperature, and the topcoat was applied thereon. The other five plaques were flashed for about 20 minutes and were then baked at about 125 degrees Celsius for about 15 minutes. In both sets, the polyurethane coating passed the 10-day water immersion. The topcoat was applied and baked under standard conditions at about 125 degrees Celsius for about 60 minutes.

A polyurethane formulation may include an aqueous polyurethane such as L-2896 mentioned above with water and 2-butoxyethanol. This may be applied by flow application. Moreover, the polyurethane formulation may include an aqueous polyurethane formulation such as L-2896, water, 2-butoxyethanol and Tin 479. This too may be applied by flow application. Furthermore, the same formulation may be completed by spray application. For example, a base formulation and testing procedure are provided in Table 4 below.

TABLE 4
Base formulation (DMM version - No UVA - Wet-on-Wet)

Tested 10 day WI - Adhesion, 30 day water soak, Lap shear, ecosphere, -
Passed, Heat Aging (7 week). Honda thermal cycle similar performance as
an acrylic primer.

The properties of the polyurethane dispersion used in the polyurethane primer are provided in Tables 5 and 6 below.

TABLE 5
Physical properties

| | |
|---|---|
| Solids | 35% |
| Viscosity | 50-500 cps |
| VOC content | 126 g/L |
| Softening point | 166 C. |

TABLE 6
Tensile properties
(tested at 20 inches/minute)

| | |
|---|---|
| Elongation | 210% |
| Tensile strength | 6825 psi |
| 100% modulus | 4700 psi |
| 200% modulus | 6600 psi |

The aqueous polyurethane formulation and process are summarized below in Table 7.

TABLE 7

| | Formulation | 100% | 10000 g | Process |
|---|---|---|---|---|
| 1 | D.I. Water | 67.26 | 6726.01 | Weigh DI water |
| 2 | PUR HD-2896 | 6.82 | 682.25 | Weigh PUR into the |
| | | | | mixture, Mix |
| | | | | under low speed for 15 min |
| 3 | 2-butoxyethanol | 25.92 | 2591.75 | Weigh EB and add |
| | | | | to the mixture above |
| | Total | 100.00 | 10000.00 | Mix under low speed for |
| | | | | 15 minutes |

For this example, the aqueous polyurethane properties are summarized below in Table 8.

TABLE 8

| | |
|---|---|
| Primer solids | 2.39% |
| Application | wets out surface very well |

The aqueous polyurethane properties are further summarized below in Table 9. The haze-appearance results (30-day) shown. Specifically, the 30-day results show the delta values, indicating (see arrow) a surprisingly low haze appearance after a 30-day water immersion test at 50 degrees Celsius.

TABLE 9

| | Initial | | Day 4 | | | Day 13 | | | 30 day | | |
|---|---|---|---|---|---|---|---|---|---|---|---|
| | Haze | | Haze | | | Haze | | | Haze | | |
| Samples | ave | std dev | ave | std de [symbol] | Delta | ave | std de [symbol] | delta | ave | std dev | delta |
| Sample 1 | 0.68 | 0.11 | 0.73 | 0.13 | 0.05 | 0.76 | 0.13 | 0.08 | 0.78 | 0.22 | 0.10 |
| Sample 2 | 0.65 | 0.11 | 0.78 | 0.28 | 0.13 | 0.73 | 0.07 | 0.08 | 0.72 | 0.10 | 0.07 |
| Sample 3 | 0.62 | 0.05 | 0.62 | 0.04 | −0.01 | 0.75 | 0.08 | 0.13 | 0.71 | 0.11 | 0.08 |
| Sample 4 | 0.70 | 0.13 | 0.83 | 0.17 | 0.13 | 0.75 | 0.20 | 0.05 | 0.79 | 0.10 | 0.09 |
| Sample 5 | 0.58 | 0.06 | 0.66 | 0.06 | 0.07 | 0.66 | 0.06 | 0.07 | 0.68 | 0.10 | 0.10 |

The aqueous polyurethane properties are further summarized below in Table 10. Specifically, the 10-day adhesion results for the aqueous polyurethane dispersion, L-2896, are summarized below. In these examples, a batch of twenty 730 plaques (730 mm×730 mm) were coated with the aqueous polyurethane formulation for each condition. The wet-on-wet process with about a 40-minute flash appears to have manufacturing potential.

TABLE 10

| | | Top | | Bottom |
|---|---|---|---|---|
| Cure conditions | Top | (ASTM) | Bottom | ASTM) |
| PUR L2896/flash 20 min/bake | 100A | 100A | 100A | 100A |
| 15 min | | | | |
| PUR L2896/flash 20 min/bake | 100A | 100A | 100A | 100A |
| 15 min | | | | |
| PUR L2896/flash 20 min/bake | 100A | 100A | 100A | 100A |
| 15 min | | | | |
| PUR L2896/flash 20 min/bake | NM | NM | 99A | 100A |
| 15 min | | | | |
| PUR L2896/flash 20 min/bake | 100A | 100A | 100A | 100A |
| 15 min | | | | |
| PUR L2896/flash 40 min | 100A | 100A | 100A | 100A |
| PUR L2896/flash 40 min | 100A | 100A | 100A | 100A |
| PUR L2896/flash 40 min | 100A | 100A | 100A | 100A |
| PUR L2896/flash 40 min | 100A | 100A | 100A | 100A |
| PUR L2896/flash 40 min | 100A | 100A | 100A | 100A |

Table 11 below summarizes the thickness of the aqueous polyurethane primer on the 730 plaque. Regarding the ecosphere results, the samples passed cross hatch test, i.e., there was no observed cracking or delamination in twelve cycles. The aqueous polyurethane results were comparable to SHP-3X results. Regarding the weathering results, the samples that were in DMM and exposed to 1.03 MJ in GMOD 60 xenon arc boro/boro with CIRA coating at an irradiance of 0.70 watts/meter squared showed relatively favorable appearance and no defects. The samples in NMP were exposed to 4.1 MJ in GMOD 60 xenon arc boro/boro with CIRA coating at an irradiance of 0.70 watts/meter squared also showed relatively favorable appearance and no defects.

TABLE 11

| Distance from top of part (inches) | Primer Thickness (microns) |
|---|---|
| 1 | 0.32 |
| 2 | 0.36 |
| 4 | 0.46 |
| 7 | 0.55 |
| 12 | 0.65 |
| 16 | 0.68 |
| 20 | 0.73 |
| 24 | 0.77 |
| 27 | 0.79 |
| For part # 472-01106-08225 | |

Table 12 below summarizes the 10-day adhesion results with and without extra bake cycle of 129 C/60 minutes. With an extra bake cycle, the adhesion properties were found to be favorable.

TABLE 12

| | Exatec 900 system(primer | | | | | | | |
|---|---|---|---|---|---|---|---|---|
| | baked 125/15 min) | | | | Extra Bake Cycle (129 C/60 min) | | | |
| | TOP | | Bottom | | TOP | | Bottom | |
| | ADH | | ADH | | ADH | | ADH | |
| 030706G | TOP | ASTM | BOT | ASTM | TOP | ASTM | BOT | ASTM |
| 172-2 | 100A | 100A | 100A | 100A | 100A | ASTM | 100A | 100A |
| 172-2 | 100A | 100A | 99B | 99B | 100A | ASTM | 100A | 100A |
| 177-2 | 100A | 100A | 99B | 99B | 100A | ASTM | 100A | 100A |
| 179-2 | 100A | 100A | 99A | 100A | 100A | ASTM | 100A | 100A |
| 181-2 | 100A | 100A | 99B | 99A | 100A | ASTM | 100A | 100A |

Table 13 below summarizes the haze results for an aqueous polyurethane primer, L-2503 (mentioned above), coated on a set of 730 plaques. In this example, the base layer was soaked in water at about 50 degrees Celsius. The 10-day adhesion results are presented with and without a defroster cycle. (Part ID 8313-1; 8314-1; and 8481-1.) With an extra defroster cycle, the adhesion properties were found to be favorable. As shown, the 30-day results provide a delta haze of less than 0.25% with a standard deviation pf of less than 0.15. The polyurethane primer used in this example appeared to be less haze development at day 30 comparable to an acrylic primer at day 1.

TABLE 13

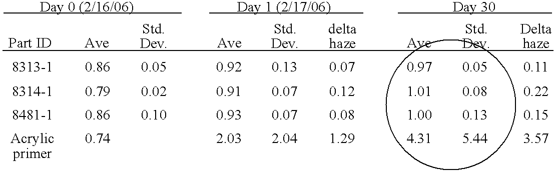

In another example, an aqueous coating composition comprising aqueous polyurethane HD-2503, an ultraviolet absorber—Uvinul 3039™ ((2-ethylhexyl)-2-cyano-3,3-diphenylacrylate by BASF), along with deionized water and 2-butoxyethanol was made and flow coated on a 730′ size polycarbonate plaque. It was baked for about 15 minunes at about 125 degrees Celsius. The coated plaque was directly transferred to the plasma reactor and subjected to various plasma conditions. Of the various conditions tried, a few of the conditions provided favorable adhesion properties to the plasma coating. Table 14 below summarizes the procedure for this example.

TABLE 14

| | 100 g | 2800 | |
|---|---|---|---|
| Components | formula | g formula | Procedure |
| DI Water | 67.63 | 1893.58 | Weigh DI water |
| Polyurethane | 36.86 | 192.08 | Weigh and mix HD-2503 with water |
| HD-2503 | | | |
| EB | 26.06 | 729.62 | Weigh and add EB(less 100 ml) |
| Uvinul-3039 | 1.38 | 38.64 | Weigh and mix Uvinul with 100 ml |
| | | | of EB. |
| | 101.93 | 2853.92 | Add Uvinul solution to the above |
| | | | mixture and agitate under slow speed |
| | | | for 15 min. |
| | 3.78 | | Filter using 1 micron filters |

The impact of the samples were studied. The samples containing the aqueous primer as observed to be ductile as shown in Table 15 below.

TABLE 15

| Polyurethane | Test Velocity | Impact Energy | Maximum Load | Energy to | Total energy | Deflection at | |
|---|---|---|---|---|---|---|---|
| Specimen ID | (ft/s) | (ft-lbs) | (lbs) | max load (ft-lbs | (ft-lbs) | max load (in.) | Comments |
| 006G-1 | 11.26 | 98.5 | 1635.05 | 44.01 | 52.27 | 0.7 | Ductile |
| 006G-2 | 11.25 | 98.3 | 1545.6 | 38.39 | 49.83 | 0.66 | Ductile |
| 006G-3 | 11.27 | 98.72 | 1599.99 | 41.77 | 52.76 | 0.69 | Ductile |
| 006G-4 | 11.26 | 98.44 | 1473.74 | 35.01 | 46.1 | 0.63 | Ductile |
| 006G-5 | 11.28 | 98.79 | 1473.01 | 34.59 | 45.84 | 0.63 | Ductile |
| 006G-6 | 11.27 | 98.75 | 1784.87 | 54.42 | 60.86 | 0.78 | Ductile |
| 006G-7 | 11.28 | 98.8 | 1641.17 | 46.04 | 53.9 | 0.72 | Ductile |
| 006G-8 | 11.28 | 98.89 | 1504.48 | 36.98 | 48.08 | 0.65 | Ductile |
| 006G-9 | 11.28 | 98.84 | 1535.15 | 38.82 | 44.31 | 0.67 | Ductile |
| 006G-10 | 11.28 | 98.83 | 1522.05 | 37.57 | 49.27 | 0.65 | Ductile |
| 006G-11 | 11.28 | 98.95 | 1571.99 | 40.89 | 49.85 | 0.69 | Ductile |
| 006G-12 | 11.29 | 99.06 | 1590.37 | 40.42 | 49.84 | 0.67 | Ductile |
| 006G-13 | 11.26 | 98.5 | 1564.11 | 37.79 | 44.89 | 0.64 | Ductile |
| 006G-14 | 11.28 | 98.85 | 1528.23 | 38.79 | 48.76 | 0.67 | Ductile |
| 006G-15 | 11.27 | 98.77 | 1553.58 | 40.19 | 50.39 | 0.68 | Ductile |
| 006G-16 | 11.27 | 98.64 | 1547.45 | 40.05 | 65.29 | 0.69 | Ductile |
| 006G-17 | 11.26 | 98.53 | 1576.37 | 41.01 | 49.55 | 0.69 | Ductile |
| 006G-18 | 11.25 | 98.34 | 966.3 | 20.36 | 27.72 | 0.64 | Ductile |
| 006G-19 | 11.25 | 98.39 | 997.81 | 22.09 | 38.19 | 0.65 | Ductile |
| 006G-20 | 11.25 | 98.27 | 921.29 | 18.2 | 25.78 | 0.58 | Ductile |
| 006G-21 | 11.23 | 98.02 | 927.79 | 19.37 | 34.14 | 0.62 | Ductile |
| 006G-22 | 11.23 | 97.98 | 1683.98 | 44.27 | 77.62 | 0.67 | Ductile |
| 006G-23 | 11.24 | 98.15 | 1754.92 | 48.64 | 56.9 | 0.7 | Ductile |
| 006G-24 | 11.22 | 97.79 | 1719.91 | 46.7 | 55.18 | 0.69 | Ductile |
| 006G-25 | 11.23 | 97.92 | 1742.59 | 49.41 | 57.88 | 0.72 | Ductile |
| 006G-26 | 11.19 | 97.35 | 1633.24 | 41.09 | 65.48 | 0.65 | Ductile |
| 006G-27 | 11.2 | 97.51 | 1618.37 | 41.36 | 71.71 | 0.66 | Ductile |
| 006G-28 | 11.22 | 97.76 | 1683.11 | 46.11 | 54.27 | 0.7 | Ductile |
| 006G-29 | 11.23 | 98 | 1618.39 | 42.15 | 50.84 | 0.67 | Ductile |
| 006G-30 | 11.18 | 97.07 | 1649.91 | 45 | 53.21 | 0.69 | Ductile |
| Average | 11.2508 | 98.3572 | 1518.8278 | 39.0495 | 51.023 | 0.6717 | |
| Std. Dev. | 0.0291 | 0.5086 | 239.2753 | 8.7526 | 11.0778 | 0.0365 | |

While the present invention has been described in terms of preferred embodiments, it will be understood, of course, that the invention is not limited thereto since modifications may be made to those skilled in the art, particularly in light of the foregoing teachings.

1. An automotive panel comprising:
a polycarbonate base layer; an aqueous polyurethane primer coated on the polycarbonate base layer, the aqueous polyurethane primer comprising less than about 10 weight percent of polyurethane and less than about 30 weight percent 2-butoxyethhanol with the remainder being deionized water; and a weatherable coating applied on the aqueous polyurethane primer.

2. The panel of claim 1 wherein the base layer comprises at least one of polycarbonate, polymethylmethyacrylate, polyester, a polycarbonate/acrylonitrile butadiene styrene blend, and a polycarbonate/polyester blend.

3. The panel of claim 1 further comprising an abrasion resistant layer adhered to the weatherable coating for protecting the weatherable coating, the aqueous polyurethane primer, and the base layer from damage caused by abrasion.

4. The panel of claim 3 wherein the abrasion layer comprises at least one of the following components: aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, and zirconium titanate.

5. The panel of claim 1 wherein the aqueous polyurethane primer comprises less than about 7 weight percent of polyurethane and less than about 25 weight percent 2-butoxyethhanol with the remainder being deionized water.

6. The panel of claim 1 wherein the aqueous polyurethane primer comprises triethylamine.

7. The panel of claim 1 wherein the aqueous polyurethane primer comprises ultraviolet absorbing (UVA) molecules for ultraviolet light absorption.

8. The panel of claim 7 wherein the ultraviolet absorbing molecules exhibit greater than about 1 absorption unit of UV light absorption between the wavelengths of about 295 to about 345 nanometers.

9. The panel of claim 7 wherein the UVA molecules are comprised of one of the following components: inorganic oxides, benzophenones, benzoylresorcinols, cyanoacrylates, triazines, oxanilides, and benzotriazoles.

10. The panel of claim 1 wherein the aqueous polyurethane primer has a thickness of 0.2 to 7 micrometers.

11. The panel of claim 1 wherein the weatherable coating comprises at least one of the following components: acrylic, polyurethane, polyurethane acrylate copolymer, siloxane, silicone hard-coat, ionomer, and flouropolymer.

12. The panel of claim 1 wherein the aqueous polyurethane primer has an acid number about 20 mg KOH/gm dry resin.

13. An automotive panel comprising:
a polycarbonate base layer; an aqueous polyurethane primer coated on the polycarbonate base layer, the aqueous polyurethane primer having an acid number about 20 mg KOH/gm dry resin and comprising less than about 10 weight percent of polyurethane and less than about 25 weight percent 2-butoxyethhanol with the remainder being deionized water; a weatherable coating applied on the aqueous polyurethane primer; and an abrasion resistant layer adhered to the weatherable coating for protecting the weatherable coating and base layer from damage caused by abrasion.

14. The panel of claim 13 wherein the base layer comprises one of polycarbonate, polymethylmethyacrylate, polyester, a polycarbonate/acrylonitrile butadiene styrene blend, and a polycarbonate/polyester blend.

15. The panel of claim 1 wherein the primer comprises triethylamine.

16. The panel of claim 13 wherein the primer comprises ultraviolet absorbing (UVA) molecules exhibiting greater than about 1 absorption unit of ultraviolet light absorption between the wavelengths of about 295 to about 345 nanometers.

17. The panel of claim 16 wherein the UVA molecules are selected from the group of inorganic oxides, benzophenones, benzoylresorcinols, cyanoacrylates, triazines, oxanilides, and benzotriazoles.

18. The panel of claim 13 wherein the primer is in a thickness of less than about 0.2-7 micrometers.

19. The panel of claim 13 wherein the weatherable coating comprises at least one of the following components: acrylic, polyurethane, polyurethane-acrylate, siloxane, silicone hard-coat, ionomer, and flouropolymer.

20. The panel of claim 13 wherein the abrasion layer comprises at least one of the following components: aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, and zirconium titanate.
